(19) United States
(12) Patent Application Publication
(10) Pub. No.: US 2006/0131129 A1
(43) Pub. Date: Jun. 22, 2006

(54) Paving stone alignment apparatus and process

(76) Inventor: Jeffery McNear, Greenbrae, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/312,166

(22) Filed: Dec. 19, 2005

Related U.S. Application Data
(60) Provisional application No. 60/639,156, filed on Dec. 22, 2004.

(51) Int. Cl. B65G 47/24

(52) U.S. Cl. 198/373

(57) ABSTRACT

A method and apparatus for aligning the top surfaces of a single line of stones, such as paver stones, with each other has a conveyor for conveying a single-file line of stones and a recognition device for viewing each stone and determining its top surface orientation. An actuator includes a memory receiving an output from the recognition device and outputting rotational alignment information for each of the stones. The actuator and the memory cause needed rotation of the stones so that their top surfaces are aligned.

### CROSS-REFERENCES TO RELATED APPLICATIONS

This is a continuation and claims the priority of provisional patent application No. 60/639,156 filed Dec. 22, 2004.

### BACKGROUND OF THE INVENTION

The placement of manufactured “cobblestone” or other shaped pavers (such as tango pavers of pinwheel, herringbone and running bond types) on irregular surfaces such as driveways, walkways, gardens surfaces and the like has become increasingly popular. Specifically, a base from 3 to 12 inches of aggregate has an overlying sand bed covering the aggregate in an approximate 1 to 1½ inch thickness. On top of this sand layer, the manufactured paver stones are placed. Such a surface of paver stones has the advantage over concrete of not cracking. Furthermore, when the pavers either settle or rise due to ground movement, the pavers in their side-by-side arrangement correspondingly settle or rise, maintaining both their traffic surface and a natural decorative appearance.

These manufactured paver stones have special configurations to accommodate their pavement placement. In the usual case, the pavers are constructed in a three-dimensional rectilinear configuration. Simply stated, the pavers have a top surface which imparts the desired texture and color to the paved surface. This texture and color covers a myriad of possible decorative surfaces including natural stone molding, color brick molding, multicolor patterns, and the like.

The bottom surface of such pavers is typically plain and molded only with placement to the underlying sand surface in mind. As a consequence, the pavers have a “top side” and a “bottom side” which simply must not be confused.

In the case of the rectilinear pavers and in addition to the top and the bottom surfaces, four sides are molded to extend between the top and bottom surfaces. Since the pavers are laid in a side-by-side arrangement, spacer ribs are typically integrally molded into the manufactured pavers. These spacer ribs extend approximately ⅛ of an inch outwardly from the sides of the paver. The idea behind these spacer ribs is to provide a spatial interval between adjacent side-by-side pavers. This spatial interval imparts a decorative appearance and cooperates with the underlying sand layer to provide an aesthetic, semi-permanent side-by-side spacing of the pavers, even when the pavers rise or settle.

It is desired that the spacing ribs be substantially “invisible” to those walking or driving on the pavers' traffic surface. For this reason, the spacer ribs typically extend from the bottom surface all along the side, ending ¼ to ⅛ of an inch from the top surface. The spacer ribs' primary purpose is to create a void into which sand can be vibrated to lock the pavers into place. The sand is an integral part of the interlocking paver system.

Not all interlocking pavers have ribs that stop short of the top surface. Some have ribs that go all the way up, which can make them easier to mechanically handle. Some pavers are manufactured without any ribs at all.

It is frequently desired to impart to the paver stones an irregular and random appearance. To achieve this appearance, the stones are typically tumbled in a rotating tube or barrel so that irregular and random chips and/or markings are placed on the stones, at least at the top surface and especially at the top surface edges and corners. This paver tumbling is typically the last step in the manufacturing process before the stones are stacked and shipped for use. Typically such stacking for shipping includes placement of the paver stones with the top side up on a shipping pallet with the array of stones being wrapped to ensure stability during palletized shipment. When the stones are wrapped and shipped, it is absolutely essential that the stones be placed top side up. This enables ready identification of the pavers, and much more importantly allows the placing masons to rapidly handle and place the pavers without sorting between the respective six sides of the rectilinear pavers.

Accordingly, this application is directed to solving the problem of retrieving pavers from a tumbling apparatus and causing the pavers to be stacked and thereafter shipped in the “right-side-up” orientation.

Thus, the present invention provides a machine to automate the proper alignment of the pavers.

It is to be understood that the above problem is not unique to “paver” stones. Many other manufactured or quarried stones have similar alignment problems. Accordingly, the invention set forth herein is not to be strictly construed with respect to paver stones, although it will be seen that many of the preferred embodiments are in fact directed to such paver stones.

### BRIEF SUMMARY OF THE INVENTION

An apparatus constructed in accordance with the present invention receives a single-file line of stones and aligns each individual stone with a top surface of respective successive stones to uniformly align the stones side-by-side. The stones are received in a uniform line and conveyed to a recognition station for receiving a plurality of the side-by-side stones. The recognition station has a corresponding plurality of stone receiving intervals for receiving one stone at each interval. Machine vision apparatus, such as laser scanners or cameras, for example, is associated with each receiving interval for viewing each of the side-by-side stones to determine top surface alignment with respect to the stone receiving interval. A rotation station receives a corresponding plurality of the side-by-side stones from the recognition station, the rotation station having a corresponding plurality of rotation intervals at the rotation station. Apparatus for discretely rotating each individual stone is provided at the rotational interval of the rotation station. Actuating apparatus, including a memory, receives machine vision apparatus output from each recognition interval of the recognition station and generates rotational alignment information that is used for rotating each individual stone so that their top surfaces (or any other surface, for that matter) are aligned. An actuating apparatus and memory causes each individual stone to be rotated, as necessary, so that the top surfaces of respective successive stones are uniformly aligned. Once the stones are properly aligned, apparatus for emptying the rotation station is employed.

### BRIEF DESCRIPTION OF THE DRAWINGS

FIG. 1 is a perspective view of an apparatus made according to the present invention including a line of bricks being conveyed first to a recognition station, second to a rotation station, and finally to a palletizing station;

FIG. 2 is a view of the recognition station at a recognition interval for recognizing the alignment of a top surface of a stone at the recognition station;

FIG. 3 is a view of the rotation station at a rotational interval for rotating a stone to align its top surface with other adjacent side-by-side stones at other adjacent rotational intervals;

FIG. 4A shows a configuration of the recognition station wherein the top surface of the stone is recognized;

FIG. 4B shows a configuration of the recognition station wherein the side surfaces of the stone are recognized for location of the top surface of the stone; and

FIG. 4C is an illustration of a manufactured stone having a surface specifically configured for recognition by vision apparatus at the recognition station.

### DETAILED DESCRIPTION OF THE INVENTION

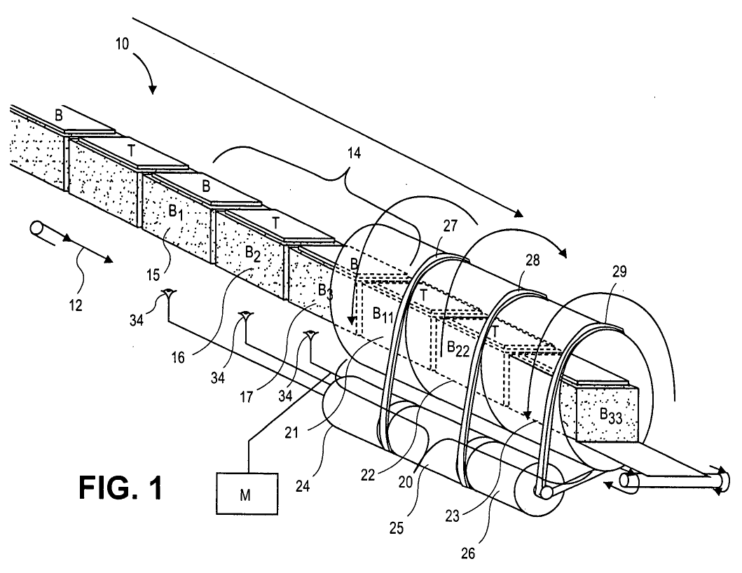

Referring to FIG. 1, brick line 10 is emanating from a tumbling barrel through a machine that places the respective bricks in a single-file line. A machine for emptying bricks from a tumbler and placing the bricks in a single-file line can be obtained from VMF Trading ApS, Industrivej 6, Orum. 8830 Tjele, Denmark.

Presuming emptying of a rotating tumbler and passage of the rectilinear bricks through a machine, the bricks emerge aligned along their major axis and are passed by conveying apparatus 12 through recognition station 14 having discrete recognition intervals 15, 16 and 17. Respective stones B1, B2 and B3 are shown at these recognition stations. Machine vision apparatus is schematically shown, has respective eyes 34, and views the corresponding stones B1, B2 and B3 to determine their orientation. For example, stone B1 has its bottom surface B directed upwardly; stone B2 has its top surface T upwardly directed; and stone B3 has its bottom surface B upwardly directed. Thus, stones B1 and B3 need to be reoriented in order to have the top surfaces T of all stones oriented upwardly. This orientation is stored in memory M. Presuming that stones B11, B22 and B33 have already been correctly aligned, stones B1, B2 and B3 will be advanced. In their advancement, they will displace respective stones B11, B22 and B33 and enter rotation station 20. Rotation station 20 includes rotation intervals 21, 22 and 23. Each rotation station includes a motor 24, 25 and 26 driving respective belts 27, 28 and 29.

Generally, sensors, such as optical, e.g. laser, sensors which view and/or scan the stones, are grouped at a selected point along the path of the stones and read the moving stream of stones as it passes this sensing point. A single sensor produces a readout that can be used to recognize the boundaries between individual stones, and also the surface details such as the presence or absence of a spacer bar. A ring or gauntlet of similar sensors that simultaneously sense multiple locations around the perimeter of the stream of stones produces a very reliable readout of the relative positions and orientations of each stone that passes through it.

Stone B3 will advance to rotation interval 23, stone B2 will advance to rotation interval 22, and stone B1 will advance to rotation interval 21. At the respective rotation intervals, a memory M stores the respective orientations at recognition station 14 and causes respective motors 24 and 26 to rotate respective rotation intervals 21 and 23 by 180° so as to orient top surface T upwardly. Thereafter, conveyance of the respective stones from the apparatus of this invention takes place.

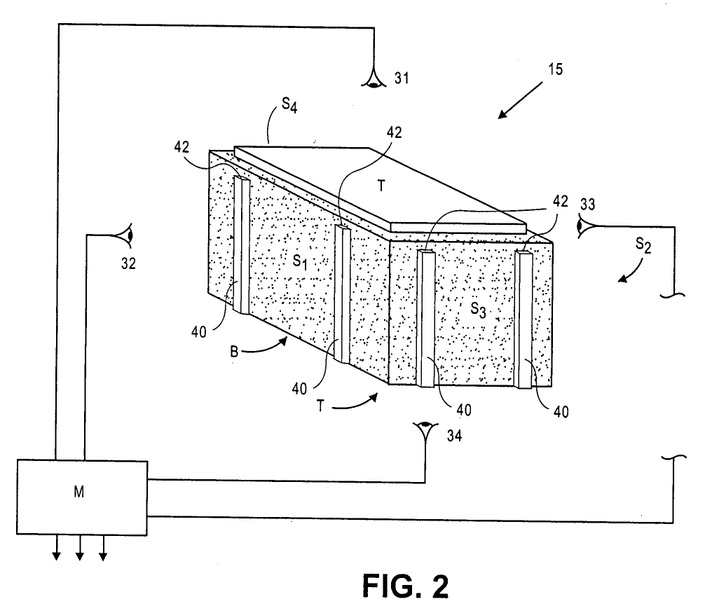

Referring to FIG. 2, a typical recognition station 15 is illustrated. There is a machine vision eye 31 which views top surface T, an eye 32 which views side S1, an eye 33 which views side S2, and an eye 30 for viewing bottom surface B.

In the usual case, manufactured stone products are recognized. Typically these products are pavers. While some surfaces are easy to recognize, other surfaces are not. Accordingly, the present invention employs several methods of recognizing paver orientation.

First, it will be observed that side S1 and side S3 each have respective spacers 40 integrally molded into the stone product. Spacers 40 stand from a plane roughly coincident to bottom surface B upwardly to and towards top surface T. However, each of the spacers 40 stops short of a plane including top surface T by approximately ¼ to ⅛ of an inch. It is possible with some paver configurations to have machine vision, such as that provided by eye 32, recognize the interval or distance 42 between where spacers 40 end and the top surface T. Typically, such machine vision will look at more than one interval 42. It should be noted that random tumbling of the stones may cause some of the intervals 42 to appear irregular.

Secondly, and with respect to some stones, top surface T may be individually recognizable, even though this surface has been tumbled against other bricks in a kiln. In this case, eye 31 can supply memory M with the orientation between bottom surface B and top surface T. Such recognition can come from color, stone texture, stone surface molding, or other distinctive textures or characteristics imparted to top surface T.

Thirdly, and remembering that the respective stones are manufactured, it may be chosen to embed coloring and/or substances such as magnetic filings in one or the other surfaces of the respective stones. These substances can be recognized by optical sensors, laser scanners, magnetic sensors, or other sensors.

In the preferred embodiment of the invention, laser distance gauges are used as sensors. As the top and bottom surfaces and sides change, other types of sensors may be better suited. Accordingly, other methods of recognition may be used as well. These can include mechanical sensors—such as those that would mechanically “feel” the sides of the stones. Further, in case of magnetic filings incorporated into one or more stone surfaces, magnetic detectors can be used. In short, since the stones are manufactured, any means that can determine the orientation of the stones can be used and is covered by this disclosure.

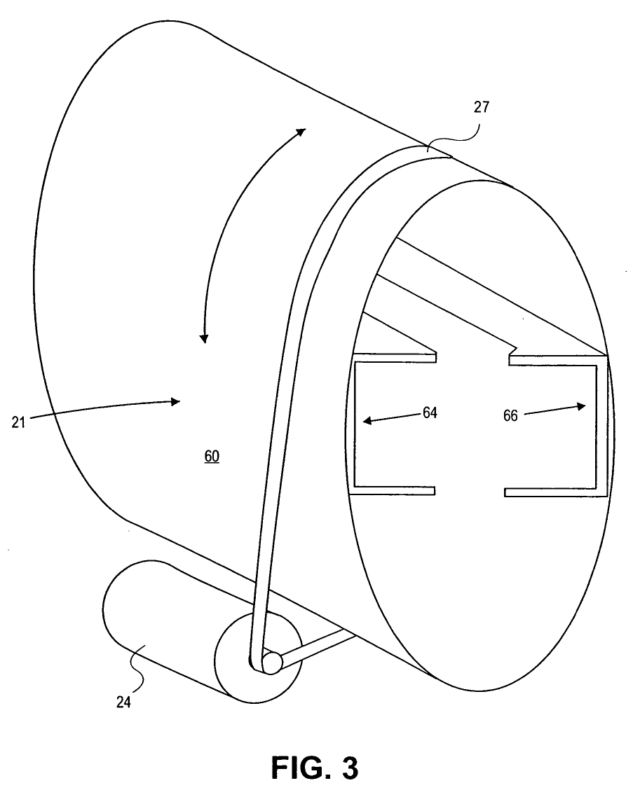

Referring to FIG. 3, a rotation interval 21 is illustrated. The rotation interval includes a cylindrical housing 60 mounted for rotation on bearings (not shown). A motor 24 drives belt 27 to rotate cylindrical housing 60. Stones are received within the stone brackets or clamps 64, 66. Upon command, motor 24 rotates belt 27, which in turn rotates cylindrical housing 60, causing the respective brackets 64, 66 and any stone therein to be reoriented. Dependent upon the information received from the recognition station 14, the degree of rotation is selected so that the top side T of every stone is oriented upwardly.

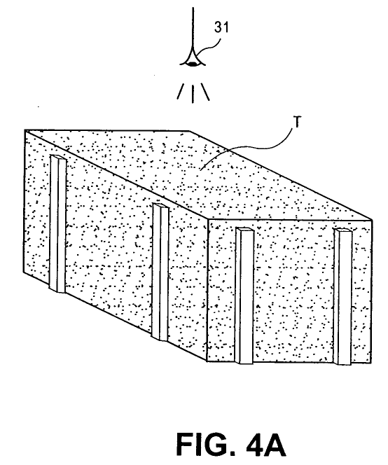

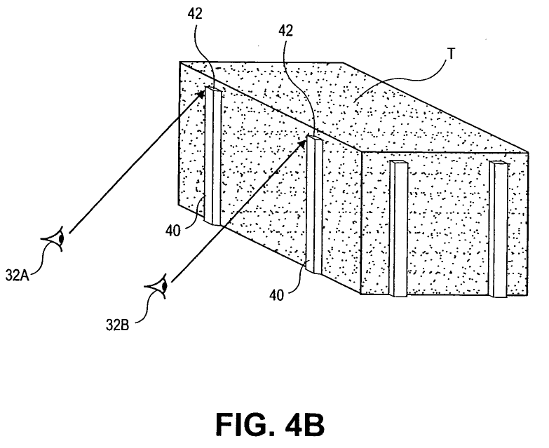

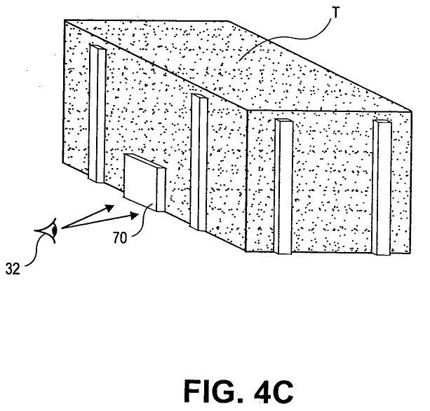

Referring to FIG. 4A, eye 31 recognizes the top surface T of a paver. Referring to FIG. 4B, respective eyes 32a and 32b recognize intervals 42 and the top of spacers 40. Finally, referring to FIG. 4C, eye 32 recognizes a special spacer pad 70 molded into the side of the illustrated manufactured stone.

Numerous alterations can be made to the manufactured stone to ease their recognition. The important point here illustrated is that these manufactured surfaces or implants to the manufactured stone cooperate with the apparatus of the present invention to enable machine alignment of the respective successive manufactured stones.

After the stones have been correctly aligned, they are typically conveyed away from the machine for standard palletizing. As such palletizing is well known, it is not further set forth herein.

The concept for correcting the orientation of the pavers by inserting them into a length of tube segments which can then be individually turned is not the only way pavers can be turned right side up. An alternative approach is to segregate the pavers into right-side-up and upside-down groups, and then rotate the upside-down ones as a group. Other diversionary and rotational apparatus could be used as well. What is important is that the rotational alignment of the passing stones in the single-file line be recorded and remembered. Thereafter, the stones may be individually rotated, grouped in accordance with their rotational alignment and then stacked, or treated in any other manner to assure uniform rotational alignment of the stones when they are delivered to a job site for use.

What is claimed is:

1. An apparatus for aligning top surfaces of a plurality of stones so that the top surfaces of the stones each are uniformly oriented comprising:
a plurality of stone receiving intervals, each interval receiving one stone;
a recognition device for viewing each of the plurality of side-by-side stones to determine an orientation of the top surface of the stones in the stone receiving intervals;
a rotation station receiving the stones from the recognition station and forming at least one rotation interval adapted to receive a stone;
a rotator for rotating the at least one rotating interval to give all stones a common orientation; and
an actuator, including a memory device providing an output regarding the orientation of the stones in the stone receiving intervals and an output to the rotation station including information for orienting the top surface of the stone in the at least one rotation interval so that the top surfaces of all stones are aligned, whereby the actuator causes each individual stone to be rotated as needed for aligning the top surfaces of the stones.

2. An apparatus according to claim 1 wherein the recognition device comprises a machine vision apparatus.

3. An apparatus according to claim 1 comprising at least three stone receiving intervals.

4. An apparatus according to claim 1 wherein the stones comprise paver stones.

5. An apparatus for receiving a single-file line of stones and aligning the top surfaces of the stones with each other comprising:
a conveyor for conveying a single-file line of stones;
a recognition device for viewing each of a plurality of stones and determining a top surface orientation of the plurality of stones; and
an actuator, including a memory receiving an output of the recognition device and outputting rotational alignment information for each of the plurality of stones, the actuator and the memory causing needed rotation of the plurality of stones so that the top surfaces of all stones are aligned.

6. A method for aligning top surfaces of a multiplicity of stones comprising:
conveying the stones in a single file through an orientation alignment device;
in the device segregating individual stones in receiving intervals;
scanning the stones as they travel through the alignment device to determine an orientation of a predetermined surface of each stone;
storing information concerning the orientation of each stone; and
thereafter rotating each stone as it passes a rotating station on the basis of orientation information for each stone stored in the memory so that downstream of the rotating station the predetermined surfaces of all stones have a common orientation.

7. A method according to claim 6 wherein the predetermined surfaces are top surfaces of each stone.

8. A method according to claim 6 and including providing each stone with a recognizable surface characteristic adapted to be readily secured during the sensing step.

9. A method for aligning a single line of stones so that the stones of the line have a uniform orientation comprising:
providing apparatus for conveying the single-file line of stones;
providing recognition apparatus for viewing each of the stones in the line and determining the orientation of the top surface of the stones in the line;
storing information regarding the top surface orientation of the stones in a memory; and
aligning the stones in the line so that their top surfaces are uniformly oriented with stone orientation information retrieved from the memory.
